(19) United States
(12) Patent Application Publication
(10) Pub. No.: US 2007/0175603 A1
(43) Pub. Date: Aug. 2, 2007

(54) Sun screen device

(75) Inventor: Paul Lin, Yung-Kang City (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Macauto Industrial Co., Ltd.

(21) Appl. No.: 11/342,176

(22) Filed: Jan. 27, 2006

(51) Int. Cl. E06B 9/56

(52) U.S. Cl. 160/273.1

(57) ABSTRACT

A sun screen device includes a pair of elongate slide rails, a shaft unit, and a flexible screen body. Each of the slide rails defines a rail groove therein. The shaft unit includes a pair of seat members and a shaft member. The shaft member has opposite shaft end portions, each of which is mounted rotatably on a respective one of the seat members. The screen body is wound on the shaft member, and has opposite lateral folded end portions, each of which is received slidably in the rail groove in a respective one of the slide rails.

### BACKGROUND OF THE INVENTION

1. Field of the Invention

This invention relates to a sun screen device that is operable so as to cover and uncover a sunroof of an automobile.

2. Description of the Related Art

A conventional sun screen device includes a pair of slide rails, a shaft unit, a screen unit, and a guide unit. Each of the slide rails defines a rail groove therein. The shaft unit includes a pair of seat members, a shaft member, and a shaft cover. The seat members are respectively disposed proximate to the first ends of the slide rails. The shaft member has opposite shaft end portions, each of which is coupled rotatably to a respective one of the seat members. The shaft cover serves to conceal the shaft member. The screen unit includes a flexible screen body for covering a sunroof of an automobile. The screen body is wound on the shaft member of the shaft unit, and has opposite lateral ends, and a middle portion that interconnects the lateral ends of the screen body. The middle portion of the screen body has an operating end that is movable away from the shaft unit such that the screen body is unwound from the shaft member of the shaft unit to thereby cover the sunroof, and toward the shaft unit such that the screen body is wound on the shaft member of the shaft unit to thereby uncover the sunroof. The guide unit serves to guide movement of the screen body. In particular, the guide unit includes a first set of spaced apart ball-shaped sliding members that are provided along one of the lateral ends of the screen body and that are disposed slidably in the rail groove of one of the slide rails, and a second set of spaced-apart ball-shaped sliding members that are provided along the other one of the lateral ends of the screen body and that are disposed slidably in the rail groove of the other one of the slide rails.

Although the conventional sun screen device can achieve its intended purpose, when the operating end of the middle portion of the screen body is moved toward the shaft unit, the ball-shaped sliding members in the first set, as well as those in the second set, overlap each other. This results in bulging at both shaft end portions of the shaft member. As such, a relatively large shaft cover is required to conceal the shaft member. Moreover, provision of the ball-shaped sliding members along the lateral ends of the screen body causes inconvenience in the manufacture of the conventional sun screen device.

### SUMMARY OF THE INVENTION

Therefore, the object of the present invention is to provide a sun screen device that can overcome the aforesaid drawbacks of the prior art.

According to the present invention, a sun screen device comprises a pair of elongate slide rails, a shaft unit, and a flexible screen body. Each of the slide rails has opposite first and second ends, and defines a rail groove therein. The shaft unit includes a pair of seat members and a shaft member. Each of the seat members is disposed proximate to a respective one of the slide rails. The shaft member has opposite shaft end portions, each of which is mounted rotatably on a respective one of the seat members. The screen body is wound on the shaft member, and has opposite lateral folded end portions, each of which is received slidably in the rail groove in a respective one of the slide rails, and a middle portion that interconnects the lateral folded end portions of the screen body. Each of the lateral folded end portions of the screen body forms an acute angle with the middle portion of the screen body.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded perspective view of the first preferred embodiment of a sun screen device according to this invention;

FIG. 2 is a fragmentary, schematic sectional view to illustrate a slide rail of the first preferred embodiment;

FIG. 3 is a perspective view to illustrate a state where a screen body is wound on a shaft member of the first preferred embodiment;

FIG. 4 is a fragmentary partly cutaway perspective view to illustrate a state where the screen body is unwound from the shaft member of the first preferred embodiment;

FIG. 5 is a fragmentary partly cutaway perspective view to illustrate a pressing member of the first preferred embodiment; and

FIG. 6 is an exploded schematic view of the second preferred embodiment of a sun screen device according to this invention.

### DETAILED DESCRIPTION OF THE PREFERRED EMBODIMENTS

Before the present invention is described in greater detail, it should be noted that like elements are denoted by the same reference numerals throughout the disclosure.

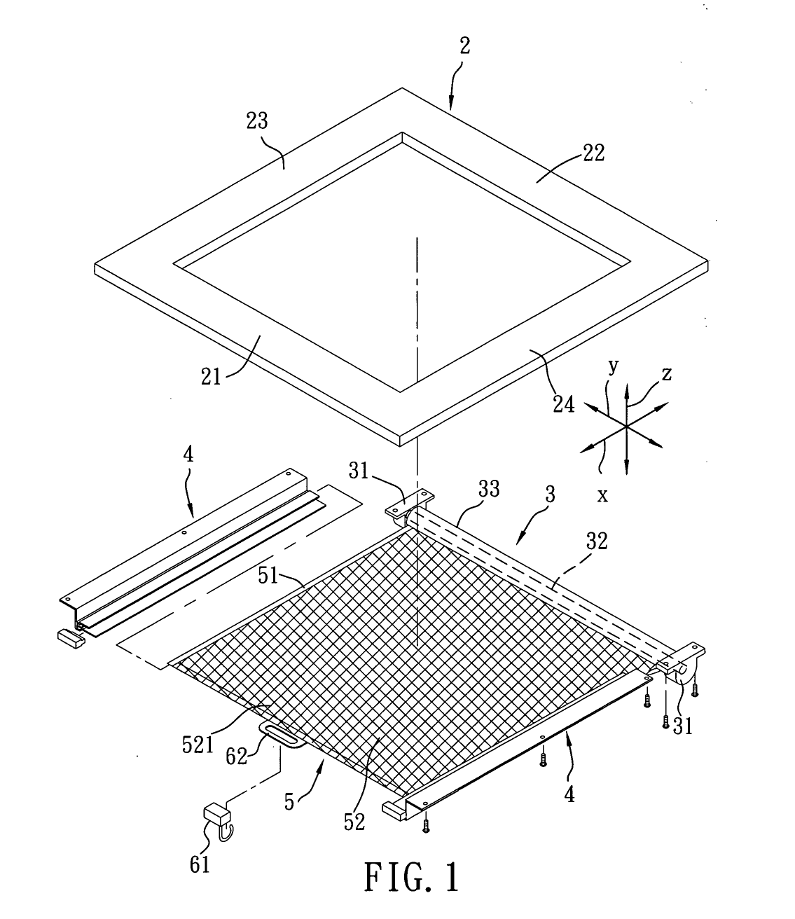

Referring to FIG. 1, the first preferred embodiment of a sun screen device according to this invention is shown to include a pair of elongate first and second slide rails 4, a shaft unit 3, and a flexible screen body 5.

The sun screen device is adapted to cover and uncover a sunroof of an automobile (not shown). In this embodiment, the sunroof includes a rectangular frame 2 on which the sun screen device is to be mounted. The frame 2 includes first and second frame parts 21, 22, which are opposite to each other in a first direction (X), and third and fourth frame parts 23, 24, which are opposite to each other in a second direction (Y) transverse to the first direction (X).

The first and second slide rails 4 are spaced apart from each other in the second direction (Y), and are respectively mounted on the third and fourth frame parts 23, 24 of the frame 2. Since the first and second slide rails 4 are identical in structure, only the first slide rail 4 will be described herein.

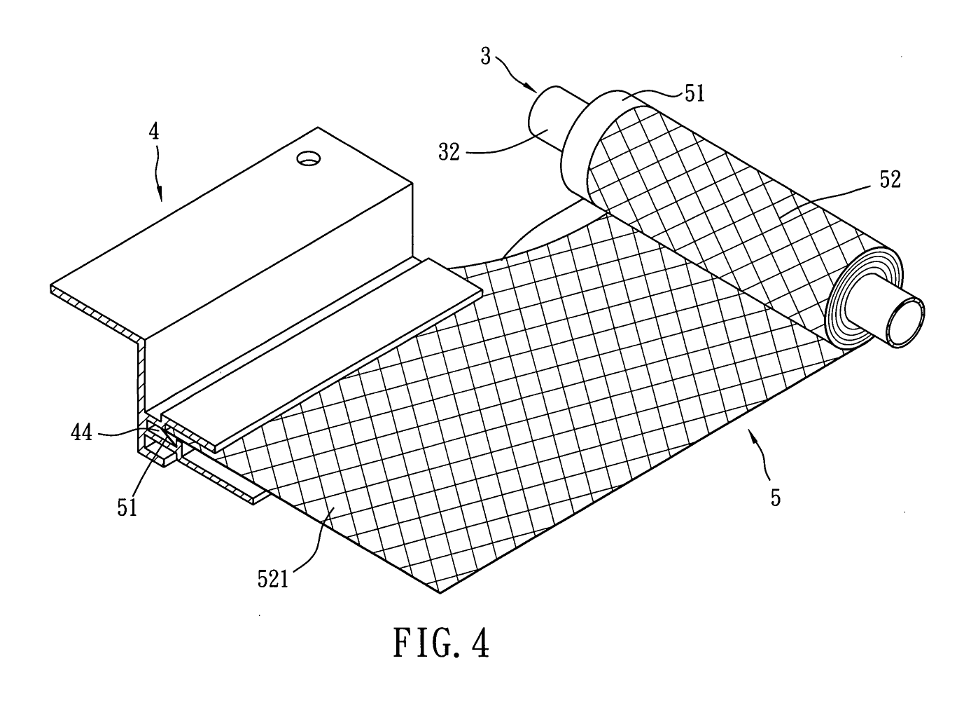

With further reference to FIG. 4, the first slide rail 4 extends in the first direction (X), and includes first, second, third, and fourth rail parts 41, 42, 43, 45.

The first rail part 41 of the first slide rail 4 is mounted on the third frame part 23 of the frame 2.

The second rail part 42 of the first slide rail 4 extends from the first rail part 41 in a third direction (Z), which is transverse to the first and second directions (X, Y), away from the frame 2.

The third rail part 43 of the first slide rail 4 includes first, second, and third portions 431, 432, 433. The first portion 431 of the third rail part 43 extends from the second rail part 42 in the second direction (Y) toward the second slide rail 4. The second portion 432 of the third rail part 43 extends from the first portion 431 of the third rail part 43 in the third direction (Z) toward the frame 2. The third portion 433 of the third rail part 43 extends from the second portion 432 of the third rail part 43 in the second direction (Y) toward the second slide rail 4.

The fourth rail part 45 includes first, second, and third portions 451, 452, 453. The first portion 451 of the fourth rail part 45 extends from the second rail part 42 in the second direction (Y) toward the second slide rail 4 and is disposed under the third rail part 43. The second portion 452 of the fourth rail part 45 extends from the first portion 451 of the fourth rail part 45 in the third direction (Z) toward the third rail part 43. The third portion 453 of the fourth rail part 45 extends from the second portion 452 of the fourth rail part 45 in the second direction (Y) toward the second slide rail 4.

The first portion 431 of the third rail part 43, and the first and second portions 451, 452 of the fourth rail part 45 of the first slide rail 4 cooperate to define a rail groove 40 there among. Moreover, the first portion 431 of the third rail part 43 and the second portion 452 of the fourth rail part 45 of the first slide rail 4 define an opening 49 that is in spatial communication with the rail groove 40.

The shaft unit 3 is mounted on the second frame part 22 of the frame 2. In this embodiment, the shaft unit 3 includes a pair of seat members 31, a shaft member 32, and a shaft cover 33. Each of the seat members 31 of the shaft unit 3 is disposed adjacent to a respective one of the first and second slide rails 4. The shaft member 32 of the shaft unit 3 has opposite shaft end portions, each of which is coupled rotatably to a respective one of the seat members 31. The shaft cover 33 of the shaft unit 3 partially covers the shaft member 32.

The screen body 5 is wound on the shaft member 32 of the shaft unit 3. In this embodiment, the screen body 5 is made from a plastic material, and has opposite lateral folded end portions 51, each of which is received slidably in the rail groove 40 in a respective one of the first and second slide rails 4, and a middle portion 52 that interconnects the lateral folded end portions 51 of the screen body 5. The middle portion 52 of the screen body 5 has an operating end 521 that is movable in the first direction (X) so as to wind or unwind the screen body 5 on and from the shaft member 32 of the shaft unit 3. Since the lateral folded end portions 51 of the screen body 5 are identical in structure, only one of the lateral folded end portions 51 of the screen body 5 will be described herein.

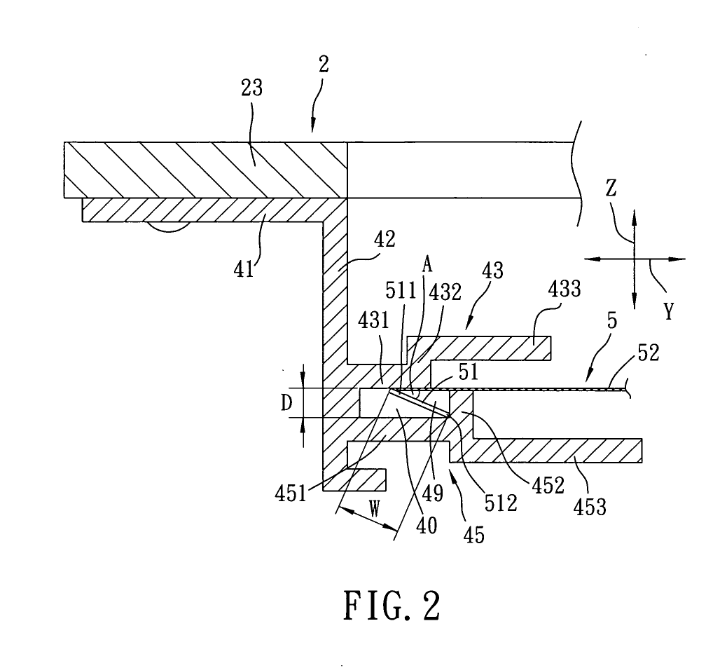

As best shown in FIG. 2, the lateral folded end portion 51 of the screen body 5 forms an acute angle (A) with the middle portion 52 of the screen body 5, and is received slidably in the rail groove 40 of the first slide rail 4 to thereby guide movement of the operating end 521 of the middle portion 52 of the screen body 5 in the first direction (X). Moreover, the lateral folded end portion 51 of the screen body 5 has a width (W) that is larger than the distance (D) between the first portion 431 of the third rail part 43 of the first slide rail 4 and the first portion 451 of the fifth rail part 45 of the first slide rail 4. Further, the lateral folded end portion 51 has a connected end 511, which is connected to the middle portion 52 of the screen body 5 and which abuts against the first portion 431 of the third rail part 43 of the first slide rail 4, and a free end 512, which is opposite to the connected end 511 and which abuts against a junction of the first and second portions 451, 452 of the fourth rail part 45 of the first slide rail 4. Hence, the lateral folded end portion 51 of the screen body 5 can be retained in the rail groove 40 in the first slide rail 4.

It is noted that the lateral folded end portion 51 of the screen body 5 has a certain degree of rigidity. In this embodiment, the lateral folded end portion 51 of the screen body 5 is formed by laminating a lateral end portion of the screen body 5.

The sun screen device further includes an engaging hook 61 that is provided on the first frame part 21 of the frame 2, and an engaging loop 62 provided on the operating end 521 of the middle portion 52 of the screen body 5.

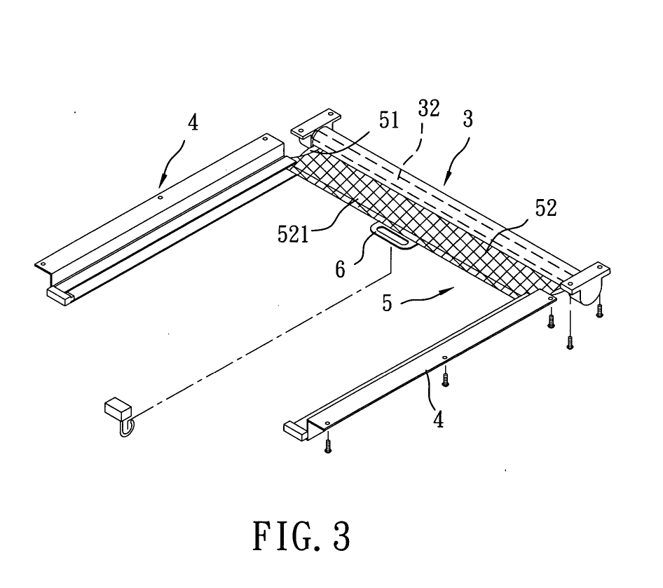

In operation, referring to FIG. 3, when an external force is applied to the operating end 521 of the middle portion 52 of the screen body 5 such that the operating end 521 moves toward the shaft unit 3, the shaft member 32 rotates in a first angular direction. This results in winding of the screen body 5 on the shaft member 32 and sliding movement of the lateral folded end portions 51 of the screen body 5 along the first and second slide rails 4, respectively, thereby uncovering the sunroof. On the other hand, with further reference to FIG. 4, when an external force is applied to the operating end 521 of the middle portion 52 of the screen body 5 such that the operating end 521 moves away from the shaft unit 3, the shaft member 32 rotates in a second angular direction opposite to the first angular direction. This results in unwinding of the screen body 5 from the shaft member 32 of the shaft unit 3, and sliding movement of the lateral folded end portions 51 of the screen body 5 along the first and second slide rails 4, respectively, thereby covering the sunroof. At this time, the engaging hook 61 can engage the engaging loop 62 to retain the operating end 521 of the middle portion 52 of the screen body 5 at its current position.

It is noted that, during winding of the screen body 5 on the shaft member 32 of the shaft unit 3, each of the lateral folded end portions 51 of the screen body 5 can be folded completely. As such, the size of the shaft cover 33 of the shaft unit 3 can be minimized.

The shaft unit 3 further includes a biasing member (not shown) for biasing the operating end 521 of the middle portion 52 of the screen body 5 toward the shaft unit 3. Since the construction and operation of the biasing member are known to those skilled in the art, a detailed description of the same will be dispensed with herein for the sake of brevity.

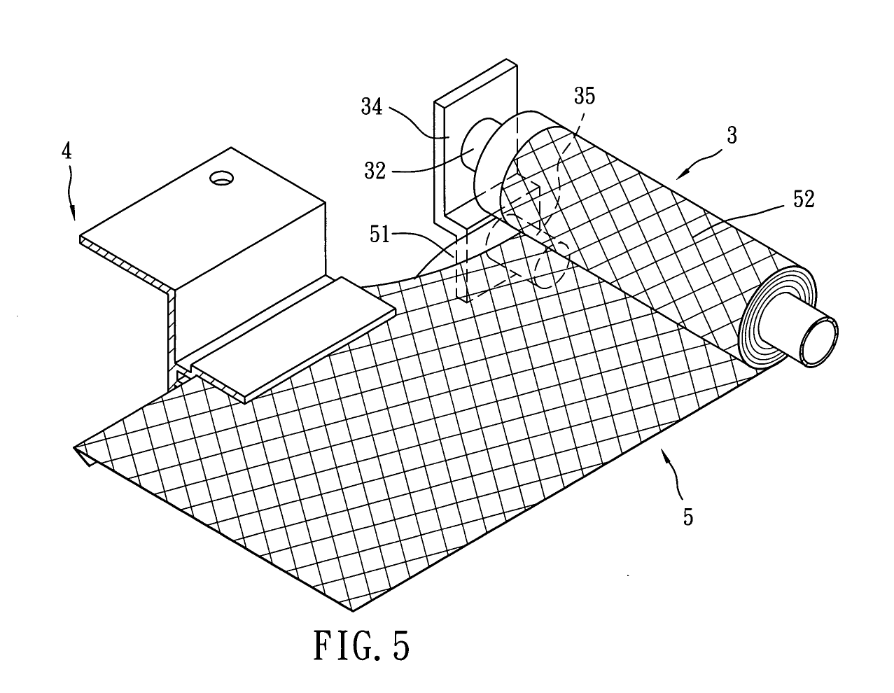

With further reference to FIG. 5, the shaft unit 3 further includes a pair of pressing members 35 (only one is shown in FIG. 5) that facilitates winding of the screen body 5 on the shaft member 32 of the shaft unit 3. Each of the pressing members 35 is coupled rotatably to a respective one of the seat members 31 of the shaft unit 3, and abuts against the middle portion 52 of the screen body 5.

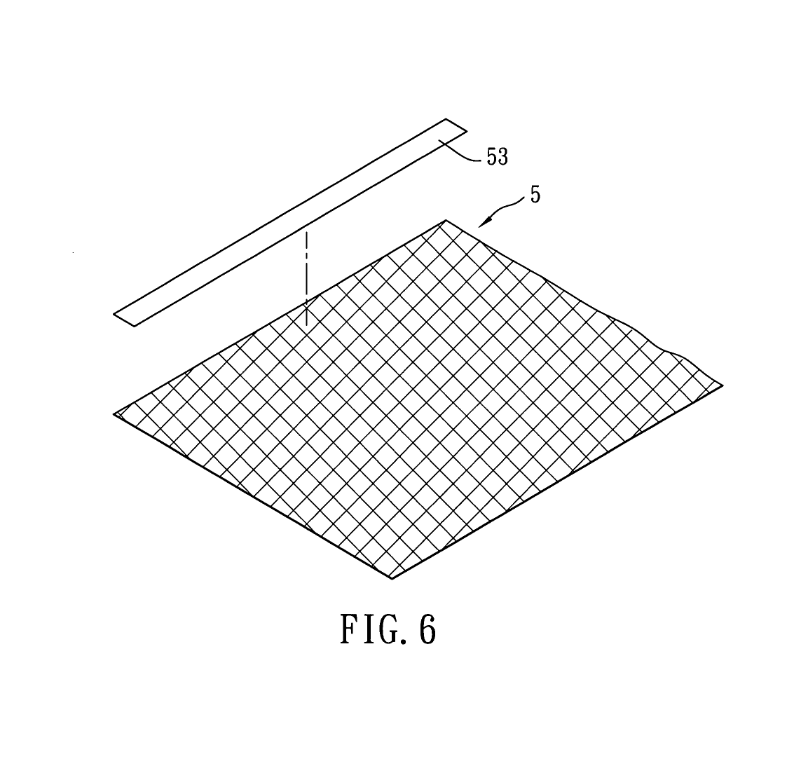

FIG. 6 illustrates the second preferred embodiment of a sun screen device according to this invention. When compared to the previous embodiment, the screen body 5 is made from a fabric material. Each of the lateral folded end portions 51 of the screen body 5 is provided with a reinforcing strip 53. In this embodiment, each of the reinforcing strips 53 includes laminated layers of plastic strips.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A sun screen device, comprising:
a pair of elongate slide rails, each of which defines a rail groove therein;
a shaft unit including
a pair of seat members, each of which is disposed proximate to a respective one of said slide rails, and
a shaft member having opposite shaft end portions, each of which is mounted rotatably on a respective one of said seat members; and
a flexible screen body wound on said shaft member, and having opposite lateral folded end portions, each of which is received slidably in said rail groove in a respective one of said slide rails, and a middle portion that interconnects said lateral folded end portions of said screen body, each of said lateral folded end portions of said screen body forming an acute angle with said middle portion of said screen body.

2. The sun screen device as claimed in claim 1, wherein each of said slide rails includes
a first rail part,
a second rail part that extends transversely from said first rail part,
a third rail part that extends transversely from said second rail part, and
a fourth rail part that extends transversely from said second rail part, and that cooperates with said third rail part to define said rail groove.

3. The sun screen device as claimed in claim 2, wherein said fourth rail part includes a first portion that extends transversely from said second rail part, and a second portion that extends transversely from said first portion of said fourth rail part toward said third rail part, said third rail part, and said first and second portions of said fourth rail part cooperating to define said rail groove.

4. The sun screen device as claimed in claim 3, wherein each of said lateral folded end portions of said screen body has a connected end that is connected to said middle portion of said screen body, and a free end that is opposite to said connected end and that abuts against a junction of said first and second portions of said fourth rail part.

5. The sun screen device as claimed in claim 1, further comprising a pair of pressing members, each of which is coupled rotatably to a respective one of said seat members of said shaft unit and each of which abuts against said middle portion of said screen body.

6. The sun screen device as claimed in claim 1, wherein said screen body is made from a plastic material.

7. The sun screen device as claimed in claim 1, wherein said screen body is made from a fabric material.

8. The sun screen device as claimed in claim 7, further comprising a pair of reinforcing strips, each of which is provided on a respective one of said lateral folded end portions of said screen body.
